(19) United States
(12) Patent Application Publication
(10) Pub. No.: US 2008/0194330 A1
(43) Pub. Date: Aug. 14, 2008

(54) Interactive game method and interactive game system with alarm function

(75) Inventors: Cho-Yi Lin, HsinChu (TW); Ming-Hui Kuo, HsinChu (TW)

Correspondence Address: Tung & Associates, Suite 120, 838 W. Long Lake Road, Bloomfield Hills, MI, 48302, US

(73) Assignee: PixArt Imaging Incorporation

(21) Appl. No.: 11/904,807

(22) Filed: Oct. 1, 2007

(30) Foreign Application Priority Data
Feb. 9, 2007 (TW) 096104824

(51) Int. Cl. A63F 13/04

(52) U.S. Cl. 463/39

(57) ABSTRACT

The present invention discloses an interactive game system with alarm function, comprising: at least one remote pointing device; and a set-up box which detects the location of the remote pointing device and generating game information according to movement of the remote pointing device, wherein the remote pointing device includes a distance detection device for detecting a distance between the remote pointing device and a nearby object, and when the detected distance is smaller than a predetermined safety threshold, the interactive game system triggers a safety mechanism.

### FIELD OF THE INVENTION

The present invention relates to an interactive game method and an interactive game system with alarm function.

### BACKGROUND OF THE INVENTION

Interactive game systems functioning in response to the 3-dimensional (3D) actions of a user have been developed, such as video baseball, table tennis, boxing, sword-fighting games and so on. In such games, a user holds a remote pointing device (such as in the shape of a table tennis racket, a baseball bat or a sword) provided by the interactive game system, and interacts (e.g., to hit a ball or to swing) with the plot displayed on a screen. The interactive game system displays corresponding scenes in response to the movement and other actions of the remote pointing device. U.S. Pat. No. 6,795,068 shows an example of such game systems.

The virtue reality effect provided by such game systems often makes a user to swing the remote pointing device drastically, which is dangerous to objects or people nearby. US Patent Publication No. 2006/0049579 discloses a remote pointing device with a safety strap, which can be tied to a user's wrist to keep the remote pointing device in place. Although this invention prevents the remote pointing device from leaving the user's hand, it is not good enough because it does not completely remove the risk of damaging objects and hurting people.

In view of the foregoing, the present invention proposes an interactive game method and an interactive game system with alarm function, to improve the above-mentioned drawbacks in prior art. Note that, although the safety issue occurs more often in the 3D interactive game systems, the present invention can be applied to any system in which a remote controller or pointing device is used.

### SUMMARY OF THE INVENTION

A first objective of the present invention to provide an interactive game method, wherein when a remote pointing device is too close to a nearby object, a safety mechanism is triggered to give an alarm or to initiate a corresponding countermeasure, so as to avoid collision between the remote pointing device and the object.

A second objective of the present invention is to provide an interactive game system.

To achieve the foregoing objectives, and from one aspect of the present invention, an interactive game system with alarm function comprises: at least one remote pointing device; and a set-up box which detects the location of the remote pointing device and generating game information according to movement of the remote pointing device, wherein when a distance between the detected location and a predetermined location is smaller than a predetermined safety threshold, the interactive game system triggers a safety mechanism.

In another aspect of the present invention, an interactive game system with alarm function comprises: at least one remote pointing device; and a set-up box which detects the location of the remote pointing device and generating game information according to movement of the remote pointing device, wherein the remote pointing device includes a distance detection device for detecting a distance between the remote pointing device and a nearby object, and when the detected distance is smaller than a predetermined safety threshold, the interactive game system triggers a safety mechanism.

Preferably, if the interactive game system includes two or more remote pointing devices, the safety mechanism is triggered when a distance between the two remote pointing devices is smaller than twice the predetermined safety threshold.

In yet another aspect of the present invention, an interactive game method with alarm function comprises: providing at least one remote pointing device; calculating the location of the remote pointing device; and when a distance between the location of the remote pointing device and a predetermined location is smaller than a predetermined safety threshold, triggering a safety mechanism.

In a further aspect of the present invention, an interactive game method with alarm function comprises: providing at least one remote pointing device; detecting a distance between the remote pointing device and a nearby object; and when the detected distance is smaller than a predetermined safety threshold, triggering a safety mechanism.

Preferably, if two or more remote pointing devices are used, the safety mechanism is triggered when a distance between the two remote pointing devices is smaller than twice the predetermined safety threshold.

For better understanding the objects, characteristics, and effects of the present invention, the present invention will be described below in detail by illustrative embodiments with reference to the attached drawings.

### BRIEF DESCRIPTION OF THE DRAWINGS

FIGS. 1A and 1B show two examples of 3D interactive game systems.

FIG. 2 explains how to calculate 3D information.

FIG. 3 explains how collisions may happen.

FIG. 4 shows an embodiment according to the present invention.

FIG. 5 shows a detailed hardware embodiment of the present invention.

### DESCRIPTION OF THE PREFERRED EMBODIMENT

The present invention will be described in detail with reference to 3D interactive games. However, as explained above, the present invention can be applied to any system in which a remote controller or pointing device is used. Furthermore, there are multiple ways to implement the hardware of a 3D interactive game and to calculate 3D information; what are described below is to demonstrate that the present invention has reached a practicable stage, for enabling those skilled in this art, but should not be taken as limitations to the scope of the present invention.

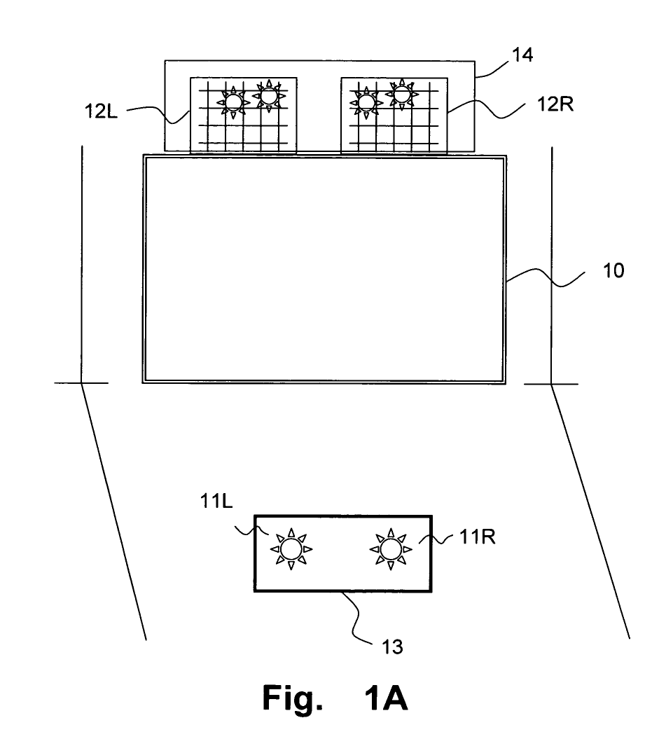

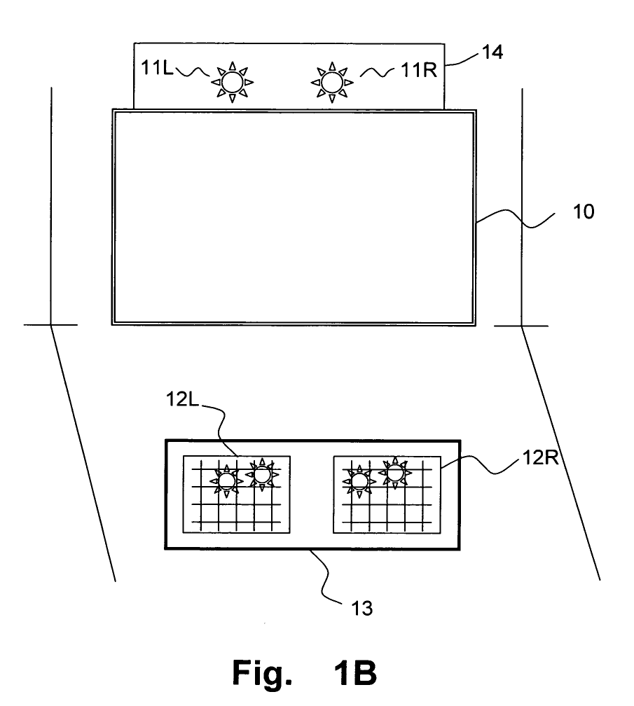

Referring to FIGS. 1A and 1B, in one arrangement of a 3D interactive game, at least one light emission source and two sensors are provided; the sensors sense the light emitted from the light emission source, and the sensed result is transformed into 3D stereo information. The light emission source and the sensors can be separately provided on the set-up box and the remote pointing device, or arranged otherwise. In one example, the light emission source is located alone, separated from both the set-up box and the remote pointing device, and communicated with them in wired or wireless manner. In the embodiment shown in FIG. 1A, the light emission sources 11L and 11R are provided on the remote pointing device 13; the sensors 12L and 12R are provided on the set-up box 14 (or an extended receiver connected to the set-up box, which is not shown); the set-up box 14 is located on top of the screen 10. In the embodiment of FIG. 1B, the light emission sources 11L and 11R and the sensors 12L and 12R are arranged in a different manner. (In these drawings, the set-up box and the remote pointing device are shown in an abstract form). The 3D information of the remote pointing device can be obtained according to the image generated by the light emission source, the distance between the two sensors, and the focal distances of the two sensors.

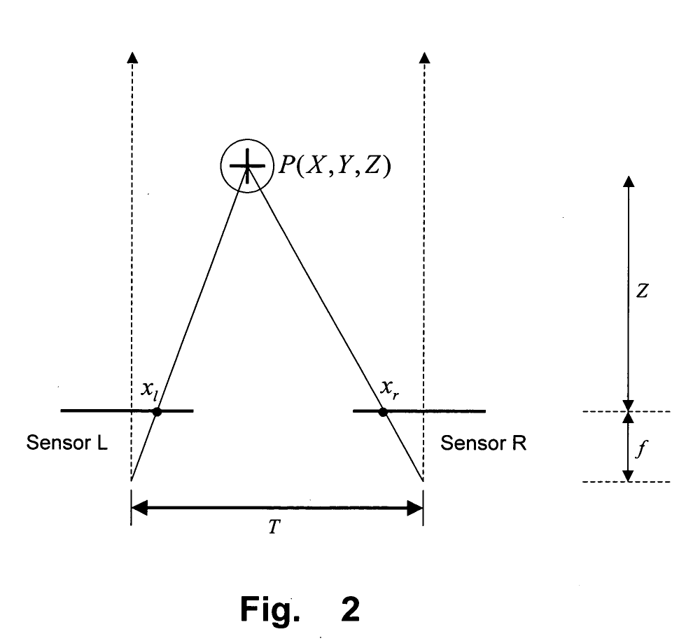

More specifically, as shown in FIG. 2, if the distance between the center positions of the left and right sensors is T; the focal distance of each of the sensors is f; the x coordinate of an object in the 2D information obtained by the left sensor is x₁, and its x coordinate in the 2D information obtained by the right sensor is xᵣ (which is a negative value because it is located at the left side of the center position of the right sensor, if the center position of a sensor is defined as the original point); and the distance between the object and the sensor plane is Z, then, according to the principle of similar triangles,

x₁/f=X/Z, and −xᵣ/f=(T−X)/Z

The 3D information of the object can be obtained as:

X=(T×x₁)/(x₁−xᵣ)

Y=(T×y₁)/(x₁−xᵣ)

(wherein y₁ is not shown in the figure)

Z=f×[T/(x₁−xᵣ)]

Thus, the 3D information of each point of the object can be obtained.

The calculation above is only one among many possible methods to obtain the 3D information; there are many alternatives to achieve the same result. For example, the system may include only one sensor to capture images, and a gyroscope to locate the position of the remote pointing device. The 3D information can be obtained from the image information and the location information. All such alternative methods are applicable to the present invention.

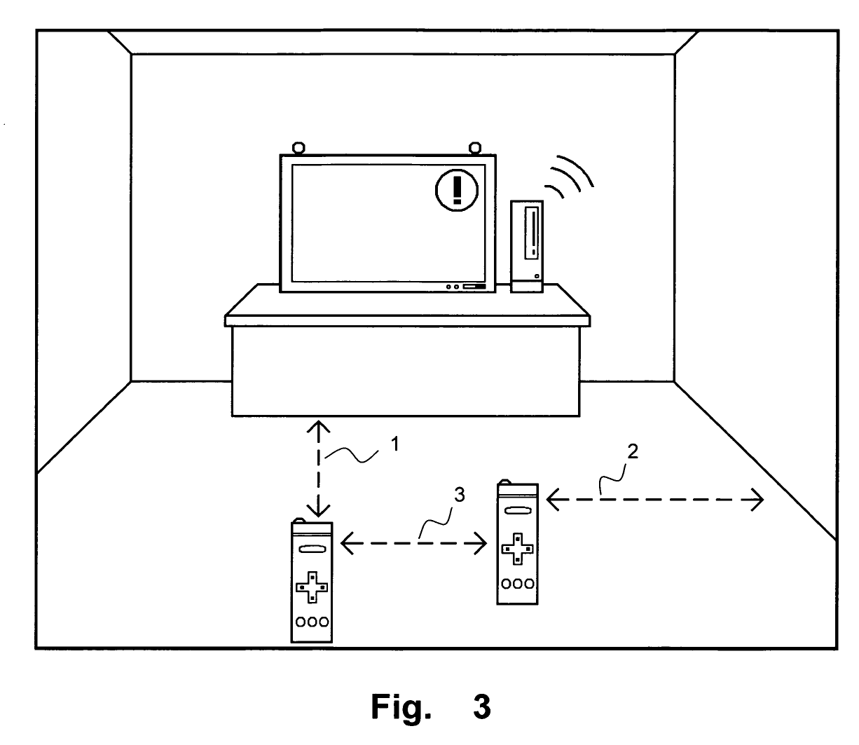

Referring to FIG. 3, in one embodiment, the remote pointing device is a remote controller; however, its appearance can be changed to a baseball bat, a sword, etc., in other embodiments. According to the present invention, there are three types of collisions that may occur:
(1) Collision between the remote pointing device and the home appliance that the set-up box or its extended receiver is located at, such as a television set (as shown by the arrow 1);
(2) Collision between the remote pointing device and an object or people nearby, such as a family member, sofa, wall, etc. (as shown by the arrow 2); and
(3) Collision between two or more remote pointing devices.

The countermeasures to the above are described below. Please note that the embodiments described hereinafter should not be taken as limitations. Those skilled in this art can certainly think of many variations under the teachings of the present invention.

I. Collision Between the Remote Pointing Device and the Home Appliance where the Set-Up Box is Located at

During the aforementioned calculation for 3D information, the distance Z between the remote pointing device and the set-up box or its extended receiver has been obtained. According to the present invention, a safety mechanism may be set up such that when the distance Z is smaller than a safety threshold, an alarm is generated, or some other countermeasure is taken. The “safety threshold” for example may be [(the length l of the remote pointing device plus the average length L of the arm of an adult) multiplied by a safety factor R], wherein R can be set as 1.0, 1.1, 1.2, . . . ; the safety mechanism is triggered when Z□(l+L)*R. The value of R can be set by a user if necessary. The alarm or the countermeasure for example may be one or more of the following: displaying a warning symbol or sentence on the screen; generating an audible sound of alarm or comprehensive language; shutting down the screen; stopping the game; leading the user to move towards a safer area in an interactive way (for example, by zooming in the displayed view or moving the view forward so that the user is induced to move back); and so on.

Besides setting the safety mechanism according to the distance Z, the following method to avoid collision between the remote pointing device and an object or people nearby can also be applied here to avoid collision between the remote pointing device and the set-up box.

II. Collision Between the Remote Pointing Device and an Object or People Nearby

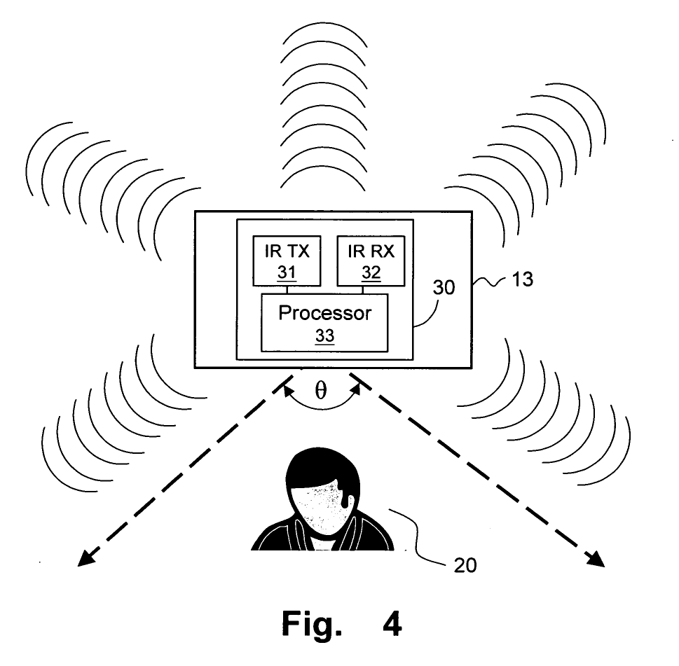

Referring to FIG. 4, to avoid collision between the remote pointing device and an object or people nearby, a distance detection device 30 can be provided in the remote pointing device 13 to detect the distance between the remote pointing device and a nearby object. Distance detection has been a mature technique; for example, the distance can be calculated by measuring the time from light emitting from an infrared transmitter (IR TX) 31 to light received by an infrared receiver (IR RX) 32, and converting the time to a distance by a processor 33. According to the present invention, if the interactive game system and the distance detection device both use infrared light, the infrared frequency of the distance detection device should be different from that of the interactive game system to avoid interference. Furthermore, as shown in the figure, the angle of the infrared light transmission should preferably not cover where the user 20 is located to avoid misjudgment. The safety mechanism is triggered when the distance detected by the distance detection device is smaller than a safety threshold. In one embodiment, the remote pointing device only determines the distance and transmits the distance data to a processor in the set-up box, but leaves the judgment whether to trigger the safety mechanism to the processor in the set-up box. In another embodiment, the safety mechanism is triggered according to the judgment by the remote pointing device.

There are other alternatives to the above mentioned embodiments. As an example, if the interactive game system is used in a dedicated zone wherein all objects are known, the locations of the objects can be preset to the system, and the 3D information of the remote pointing device can be compared with the locations of the known objects. The required calculation in this method is relatively more complicated, but it provides the advantage that it is not required to install a distance detection device in the remote pointing device. As another example, a distance detection device can be installed at the screen side, such as in the set-up box or its extended receiver, and the processor in the set-up box determines whether to trigger the safety mechanism according to the distance detection of the objects. In this method, any object or people entering the game zone should preferably include a light source or a reflective surface.

III. Collision Between Two or More Remote Pointing Devices

If the interactive game system provides two or more remote pointing devices, any of the above mentioned methods can be used to measure the distance between two remote pointing devices, that is, to measure the distance by the 3D information calculated by the game system, or to measure the distance by distance detection devices. Note that because the two remote pointing devices may move in opposite directions, the safety threshold should preferably be defined as twice the safety threshold when there is only single movement by single remote pointing device.

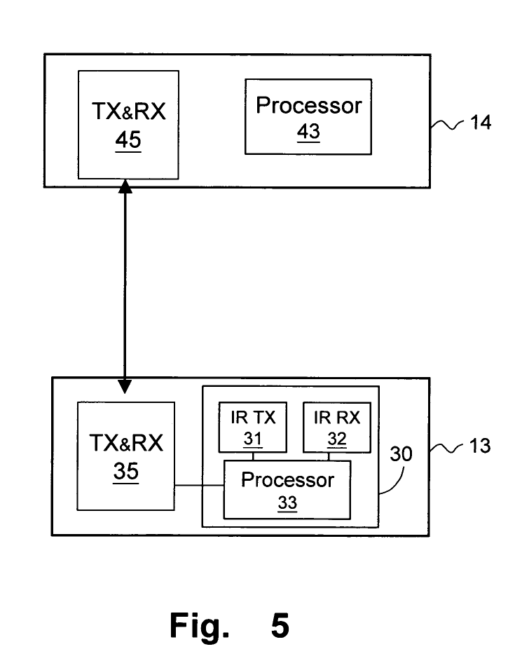

An embodiment to perform the foregoing methods is shown in FIG. 5. A distance detection device 30 is provided in the remote pointing device 13; the distance detection device 30 includes an infrared transmitter (IR TX) 31, an infrared receiver (IR RX) 32, and a processor 33. The remote pointing device 13 further includes a wireless transceiver (TX&RX) 35 to communicate with the wireless transceiver (TX&RX) 45 in the set-up box 14. The distance data calculated by the processor 33 is transmitted to the processor 43 in the set-up box 14 via the wireless transceivers 35 and 45, and the processor 43 determines whether to trigger the safety mechanism. The processors 33 and 43 can be any circuit with calculation function, such as CPU (Central Processor Unit), MCU (Micro-Processor Unit), DSP (Digital Signal Processor), or ASIC (Application Specific Integrated Circuit).

The features, characteristics and effects of the present invention have been described with reference to its preferred embodiments, for illustrating the spirit of the invention rather than limiting the scope of the invention. Various other substitutions and modifications will occur to those skilled in the art, without departing from the spirit of the present invention. For example, the present invention can be applied to any game system or any application that requires to avoid collision. The communication between the remote pointing device and the set-up box can be done by any means other than in a wireless manner. The distance detection is not limited to using infrared light. Each of the circuits shown in one circuit block does not have to be a single IC; it can be integrated with any other block, or include other functional circuits. Thus, all such substitutions and modifications are intended to be embraced within the scope of the invention as defined in the appended claims.

What is claimed is:

1. An interactive game system with alarm function, comprising:
at least one remote pointing device; and
a set-up box which detects the location of the remote pointing device and generating game information according to movement of the remote pointing device,
wherein when a distance between the location of the remote pointing device and a predetermined location is smaller than a predetermined safety threshold, the interactive game system triggers a safety mechanism.

2. The interactive game system according to claim 1, wherein the predetermined location includes one or more of the following: the location where the set-up box is, the location where a receiver of the set-up box is, the location of a known object, and the location of another remote pointing device.

3. The interactive game system according to claim 1, wherein the safety threshold is equal to [(the length of the remote pointing device plus the average length of the arm of an adult) multiplied by a safety factor].

4. The interactive game system according to claim 1, wherein the interactive game system displays graphic information on a screen, and the safety mechanism includes one or more of the following: displaying a warning symbol on the screen; displaying a warning sentence on the screen; generating an audible sound of alarm; generating an audible sound of a comprehensive language; shutting down the screen; stopping the game; and leading the user to move towards a safer area in an interactive way.

5. The interactive game system according to claim 1, comprising at least two remote pointing devices, and wherein when the distance between the locations of the two remote pointing devices is smaller than twice the safety threshold, the interactive game system triggers a safety mechanism.

6. An interactive game system with alarm function, comprising:
at least one remote pointing device; and
a set-up box which detects the location of the remote pointing device and generating game information according to movement of the remote pointing device,
wherein the remote pointing device includes a distance detection device for detecting a distance between the remote pointing device and a nearby object, and when the detected distance is smaller than a predetermined safety threshold, the interactive game system triggers a safety mechanism.

7. The interactive game system according to claim 6, wherein the distance detection device includes a transmitter, a receiver, and a processor, the processor calculates the distance according to a time between when a signal is transmitted from the transmitter and when the signal is received by the receiver.

8. The interactive game system according to claim 7, wherein the transmitter transmits the signal toward a limited angular range so as not to cover an area where a user of the interactive game system is.

9. The interactive game system according to claim 6, wherein the safety threshold is equal to [(the length of the remote pointing device plus the average length of the arm of an adult) multiplied by a safety factor].

10. The interactive game system according to claim 6, wherein the interactive game system displays graphic information on a screen, and the safety mechanism includes one or more of the following: displaying a warning symbol on the screen; displaying a warning sentence on the screen; generating an audible sound of alarm; generating an audible sound of a comprehensive language; shutting down the screen; stopping the game; and leading the user to move towards a safer area in an interactive way.

11. The interactive game system according to claim 6, comprising at least two remote pointing devices, and wherein when the distance between the locations of the two remote pointing devices is smaller than twice the safety threshold, the interactive game system triggers a safety mechanism.

12. An interactive game method with alarm function, comprising:
providing at least one remote pointing device;
calculating the location of the remote pointing device; and
when a distance between the location of the remote pointing device and a predetermined location is smaller than a predetermined safety threshold, triggering a safety mechanism.

13. The interactive game method according to claim 12, further comprising: providing a set-up box including a receiver for receiving information from the remote pointing device to calculate the location of the remote pointing device, and wherein the predetermined location includes one or more of the following: the location where the set-up box is, the location where the receiver of the set-up box is, the location of a known object, and the location of another remote pointing device.

14. The interactive game method according to claim 12, further comprising: displaying graphic information on a screen according to information from the remote pointing device, and the safety mechanism includes one or more of the following: displaying a warning symbol on the screen; displaying a warning sentence on the screen; generating an audible sound of alarm; generating an audible sound of a comprehensive language; shutting down the screen; stopping the game; and leading the user to move towards a safer area in an interactive way.

15. The interactive game method according to claim 12, further comprising: when two or more remote pointing devices are used, triggering the safety mechanism when the distance between the locations of the two remote pointing devices is smaller than twice the safety threshold.

16. An interactive game method with alarm function, comprising:
providing at least one remote pointing device;
detecting a distance between the remote pointing device and a nearby object; and
when the detected distance is smaller than a predetermined safety threshold, triggering a safety mechanism.

17. The interactive game method according to claim 16, wherein the distance detection step includes: transmitting a signal by the remote pointing device; receiving the signal; and determining the distance according to the time between when the signal is transmitted and when the signal is received

18. The interactive game method according to claim 17, wherein the remote pointing device transmits the signal toward a limited angular range so as not to cover an area where a user of the remote pointing device is.

19. The interactive game method according to claim 16, further comprising: displaying graphic information on a screen according to information from the remote pointing device, and the safety mechanism includes one or more of the following: displaying a warning symbol on the screen; displaying a warning sentence on the screen; generating an audible sound of alarm; generating an audible sound of a comprehensive language; shutting down the screen; stopping the game; and leading the user to move towards a safer area in an interactive way.

20. The interactive game method according to claim 16, further comprising: when two or more remote pointing devices are used, triggering the safety mechanism when the distance between the locations of the two remote pointing devices is smaller than twice the safety threshold.
